(19) United States
(12) Patent Application Publication
(10) Pub. No.: US 2020/0377053 A1
(43) Pub. Date: Dec. 3, 2020

(54) VEHICLE-USE OBJECT PROTECTION DEVICE

(71) Applicant: HONDA MOTOR CO., LTD., Tokyo (JP)

(72) Inventors: Masaki UMEZAWA, Wako-shi (JP); Kenyu OKAMURA, Wako-shi (JP); Hidetoshi NAKAMURA, Wako-shi (JP); Hyejin BAE, Wako-shi (JP)

(21) Appl. No.: 16/884,695

(22) Filed: May 27, 2020

(30) Foreign Application Priority Data
May 31, 2019 (JP) 2019-103287

(51) Int. Cl. B60R 21/36; B60W 30/095; G06K 9/00

(52) U.S. Cl. CPC B60R 21/36; B60R 2021/346; G06K 9/00805; B60W 30/0956

(57) ABSTRACT

Provided is a vehicle-use object protection device to suitably protect an object to be protected when the object collides with a vehicle. The device includes: a protection mechanism to protect the object from a collision with the vehicle; a collision prediction unit to predict a collision inclusive of a collision between the vehicle and at least a cyclist; a sensor to output an output value depending on an impact state when the vehicle collides with the object; and a control device. The control device compares the output value with a predetermined threshold, and activates the protection mechanism when the output value exceeds the threshold and then lowers the threshold when the collision prediction unit determines that the vehicle would collide with a cyclist.

### CROSS-REFERENCE TO RELATED APPLICATION

This application claims the benefit of priority to Japanese Patent Application No. 2019-103287 filed on 31 May 2019, the disclosures of all of which are hereby incorporated by reference in their entireties.

### TECHNICAL FIELD

The present invention relates to a vehicle-use object protection device.

### BACKGROUND OF THE INVENTION

Japanese Patent Application Publication No. 2006-044325A describes in abstract, “a pedestrian protecting device, mounted on a vehicle to protect a pedestrian by deploying an airbag when the vehicle has collided with the pedestrian, effectively reduces impact to the pedestrian by precluding the pedestrian from ranging out from upon the deployed airbag.”

### SUMMARY OF THE INVENTION

### Problems to be Solved

Incidentally, an airbag or the like protects not only a pedestrian but also a cyclist, for example, or the like. A cyclist is different from a general pedestrian in terms of a form, and therefore the behavior of a cyclist when colliding with a vehicle is also different from that of a general pedestrian. For this reason, if a vehicle-use object protection device, such as an airbag, is configured only for a general pedestrian, an object to be protected may not be suitably protected. The present invention has been made in view of the above circumstances, and is intended to provide a vehicle-use object protection device to suitably protect an object to be protected when the object collides with a vehicle.

### Solution to Problem

A vehicle-use object protection device according to the present invention solves the above problems and includes: a protection mechanism to protect an object to be protected from a collision with a vehicle; a collision prediction unit to predict a collision inclusive of a collision between the vehicle and at least a cyclist; a sensor to output an output value depending on an impact state when the vehicle collides with the object; and a control device to compare the output value with a predetermined threshold, and to activate the protection mechanism when the output value exceeds the threshold and then to lower the threshold when the collision prediction unit determines that the vehicle would collide with a cyclist.

### Advantageous Effects of the Invention

The present invention allows an object to be protected to be suitably protected when the object collides with a vehicle.

### BRIEF DESCRIPTION OF DRAWINGS

FIG. 1 is a front view of a vehicle having a vehicle-use object protection device according to an embodiment of the present invention;

FIG. 2 is a control block diagram of the vehicle-use object protection device;

FIG. 3 illustrates examples of various collisions predicted by a protected object state detector;

FIG. 4 is a chart showing an example of an output signal of a pressure sensor;

FIG. 5 is a chart illustrating various thresholds applied to the present embodiment;

FIG. 6 is a schematic diagram to show general operation of the present embodiment;

FIG. 7 is a flowchart of a camera/radar determination routine; and

FIG. 8 is a flowchart of a sonar reaction routine.

### EMBODIMENTS OF THE INVENTION

### Configuration of Embodiment

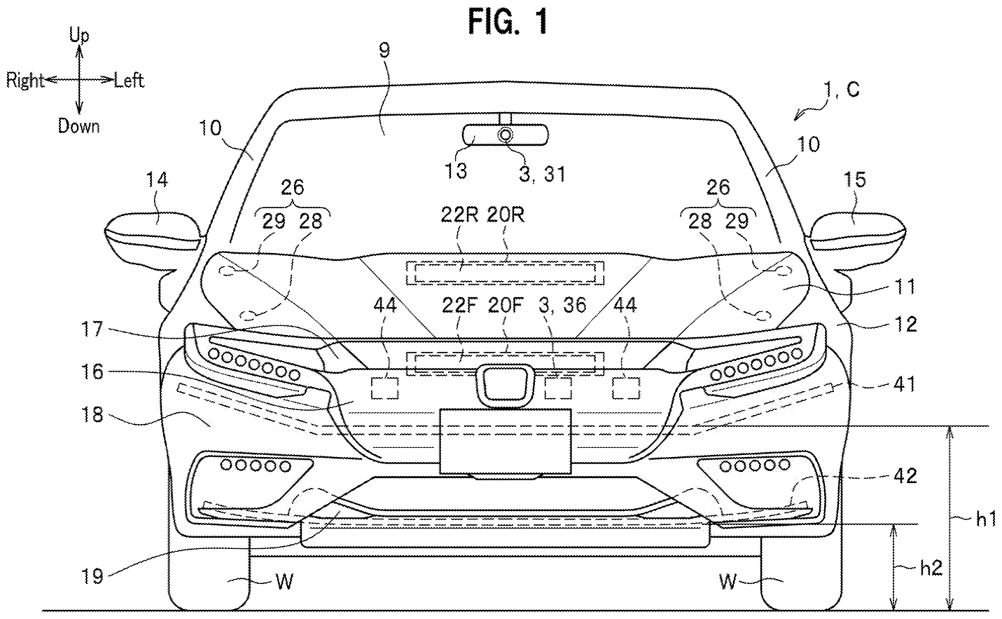

Hereinafter, embodiments of the present invention are described in detail, with reference to the drawings as required. FIG. 1 is a front view of a vehicle C having a vehicle-use object protection device 1 according to an embodiment of the present invention. The vehicle-use object protection device 1 is a device to protect an object to be protected (not shown) which has collided with the vehicle C. Here, the object is a vulnerable road user such as a pedestrian and a cyclist. A cyclist refers to an aggregate of a biker and a bicycle on which the biker rides. Note that the direction of the vehicle C moving forward is referred to as “front,” the direction of the vehicle C moving backward is referred to as “rear,” the vertically upward direction is referred to as “up,” the vertically downward direction is referred to as “down,” and the right and left directions of a driver (not shown) facing forward are respectively referred to as “right” and “left.”

### <Vehicle C>

As shown in FIG. 1, the vehicle C includes a windshield 9, a pair of A-pillars 10, a hood 11, fenders 12, a rearview mirror 13, door mirrors 14, 15, a hood grill 16, a hood edge cover 17, a front bumper 18, and a chin spoiler 19. A space under the hood 11 (no reference numeral assigned) is a motor room (engine room).

The pair of A-pillars 10 holds right and left ends of the windshield 9. Two actuators 28 are provided under right and left front ends of the hood 11, and two actuators 29 are provided under right and left rear ends of the hood 11. The actuators 28 and 29 lift the hood 11 and constitute a pop-up device 26. When an object to be protected collides with the vehicle C, the pop-up device 26 lifts the hood 11 to increase the distance between the hood 11 and the motor or an engine. This allows the hood 11, when the object is hit onto the hood 11, to be deformed to absorb a collision load, so that impact given to the object is cushioned as compared with the case where the pop-up device 26 is not provided.

The hood 11 includes a hood skin and a hood frame. Here, the hood skin is a plate to form an upper surface of the hood 11 in FIG. 1. The hood frame (not shown) is a member fixed to a lower surface of the hood skin and supporting the hood skin from below. The hood skin is preferably made of a member that can softly receive an object to be protected when the vehicle C collides with the object and the object is hit onto the hood 11. More specifically, the food skin is preferably formed of a plate having softness of being bent and deformed when pressed with a predetermined load or more, and elasticity.

The fenders 12 are arranged on the right and left sides of the hood 11 and cover upper portions of the front wheels W. The rearview mirror 13 is an in-room mirror provided at an upper front end in the vehicle interior. A camera 31 to detect an outside view is mounted near the rearview mirror 13. The door mirrors 14 and 15 are mirrors provided at upper front ends of right and left doors. The hood grill 16 is a member, located near a front end of the vehicle C, to take in outside air through a front end of the vehicle and guide the outside air to a radiator (not shown). The hood grill 16 has a plurality of substantially plate-shaped air guide plates, extending in the vehicle width direction, vertically arranged at suitable intervals.

A radar device 36 and a pair of right and left sonar devices 44 are arranged behind the hood grill 16 across space. The camera 31 and the radar device 36 are included in a collision prediction/detection device 3 (collision prediction unit) to be described below. Note that a general ADAS (Advanced Driver-Assistance System) can be applied to the collision prediction/detection device 3. A detection range of the collision prediction/detection device 3 is mainly a central region in front of the vehicle C, and a range detected by the pair of sonar devices 44 is wider in the right-left direction than that detected by the collision prediction/detection device 3. The front bumper 18 is a plate disposed at a front edge of the vehicle C, and is deformed at the time of a collision to protect the vehicle C. The chin spoiler 19 is disposed under the front bumper 18 and improves aerodynamic characteristics of the vehicle C. Note that the types, arrangement positions, the number of arrangements, and the like of various sensors applied to the collision prediction/detection device 3 and the like are suitably determined depending on purposes.

The hood edge cover 17 is provided between the hood 11 and the hood grill 16. The hood edge cover 17 is composed of a steel plate or the like extending in the vehicle width direction along a front end of the hood 11, and is axially supported so as to be pivotable about a portion in the right-left direction thereof as an axle. An airbag device 20F is provided under the hood edge cover 17, and an airbag 22F is housed inside the airbag device 20F. This allows the hood edge cover 17, once the airbag 22F is deployed, to be pushed up and pivoted by the airbag 22F to release the airbag 22F.

An airbag device 20R is provided under a rear of the hood 11, and an airbag 22R is housed inside the airbag device 20R. When the pop-up device 26 lifts the hood 11, the airbag 22R is deployed and covers a front of the windshield 9 and the A-pillar 10 to protect an object to be protected from these members. Note that the airbag device 20R can be mounted not only under the rear of the hood 11, but also around the windshield 9 or the A-pillar 10, such as a cowl top (not shown). In the following description, the airbag devices 20F and 20R are collectively referred to as an airbag device 20. The airbags 22F and 22R are collectively referred to as an airbag 22. A pressure sensor 41 formed in a tubular shape is provided on a back of the hood grill 16 and front bumper 18. A mounting height h1 of the pressure sensor 41 from the road surface is about 400 to 600 mm, for example.

A pressure sensor 42 formed in a tubular shape is provided under the pressure sensor 41 and on a back of the chin spoiler 19 and front bumper 18. A mounting height h2 of the pressure sensor 42 from the road surface is about 200 to 300 mm, for example. When an object to be protected collides with the vehicle C and the hood grill 16, the front bumper 18, or the chin spoiler 19 is deformed, the pressure sensors 41, 42 are pressed at the deformed portions. Then, the pressure sensors 41, 42 output detection signals corresponding to applied pressures.

### <Vehicle-Use Object Protection Device 1>

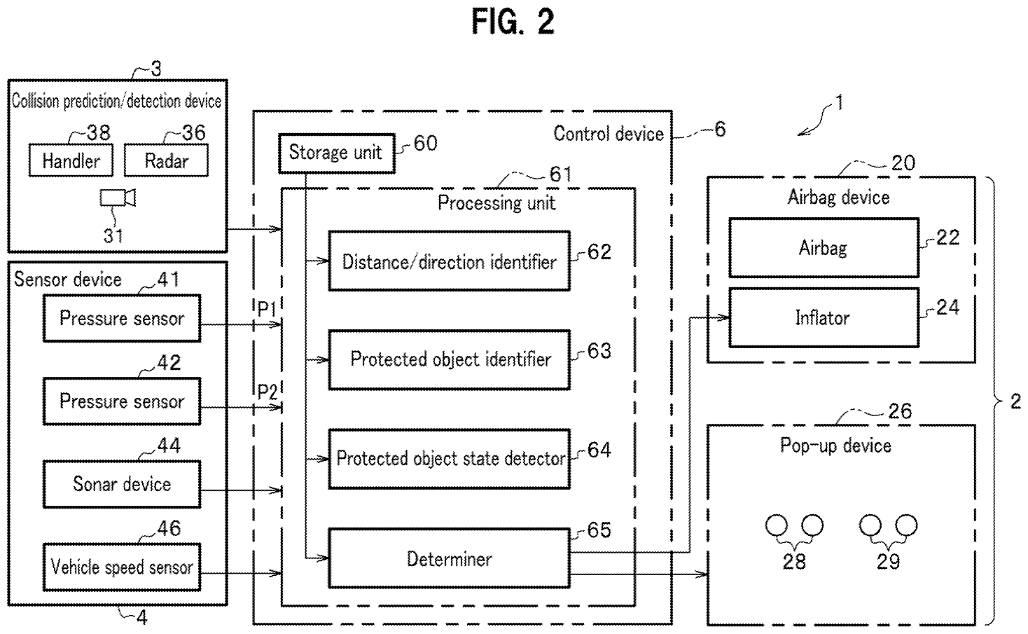

FIG. 2 is a control block diagram of the vehicle-use object protection device 1. The vehicle-use object protection device 1 includes the collision prediction/detection device 3, a sensor device 4, the airbag device 20, the pop-up device 26, and a control device 6. As both the airbag device 20 and the pop-up device 26 have a function to protect an object to be protected, they are collectively referred to as a “protection mechanism 2.” The sensor device 4 includes the pressure sensors 41 and 42, the sonar device 44, and a vehicle speed sensor 46.

The collision prediction/detection device 3 includes the camera 31, the radar device 36, and a handler 38. The radar device 36 is a radar device such as a millimeter wave radar or a laser radar. The handler 38 includes general computer hardware such as a CPU (Central Processing Unit), a DSP (Digital Signal Processor), a RAM (Random Access Memory), and a ROM (Read Only Memory). The ROM stores control programs executed by the CPU, microprograms executed by the DSP, various kinds of data, and the like.

The handler 38 uses the control programs and the microprograms to control the camera 31 and the radar device 36. As described above, the collision prediction/detection device 3 is an ADAS, for example, in the present embodiment but the camera 31 and the radar device 36 may be dedicated devices provided separately from the ADAS. The radar device 36 detects an object to be protected, detects the distance and direction from the vehicle C to the object, and outputs the results as distance information and direction information.

In addition, the pair of right and left sonar devices 44 emits sound waves to the right front and left front of the vehicle C, and then receives the reflected sound waves, to detect whether or not there is any object in the right front and left front of the vehicle C. Further, the sonar device 44 detects a relative speed between the object and the vehicle C, based on the Doppler effect in the sound waves. The above-described collision prediction/detection device 3 collects states of the object or the like in units of a relatively long control cycle (e.g., 100 milliseconds). In contrast, the right and left sonar devices 44 react at a higher response speed, in order to cope with a sudden jump of the object or the like into the vehicle's path. The vehicle speed sensor 46 detects a vehicle speed of the vehicle C based on the rotation speed of the front wheels W (see FIG. 1).

The airbag device 20 includes the airbag 22 and an inflator 24. For example, the inflator 24 includes an ignition device (not shown) electrically connected to the control device 6, a gas generating agent such as sodium azide, and a case body to house these.

The control device 6 includes a storage unit 60 and a processing unit 61. The storage unit 60 stores various data. In particular, the storage unit 60 stores information called templates that define various contour shapes of “pedestrians” and “cyclists,” as well as other appearance features. A template for a pedestrian is called a “pedestrian template” and a template for a cyclist is called a “cyclist template.” These templates are used to analyze whether or not the image information from the camera 31 includes an object to be protected.

The processing unit 61 includes hardware as a general computer, such as a CPU, a DSP, a RAM, and a ROM, as with the handler 38 described above. The ROM stores control programs executed by the CPU, microprograms executed by the DSP, various kinds of data, and the like. Inside the processing unit 61 in FIG. 2, functions implemented by the control programs, microprograms, and the like are shown in blocks.

That is, the processing unit 61 includes a distance/direction identifier 62, a protected object identifier 63, a protected object state detector 64, and a determiner 65. The processing unit 61 is provided with image information from the camera 31 of the collision prediction/detection device 3, distance information from the radar device 36, output signals P1 and P2 (output values) of the pressure sensors 41 and 42, information from the sonar devices 44, and vehicle speed information from the vehicle speed sensor 46. The processing unit 61 executes various kinds of processing, to be described later, based on the provided pieces of information.

In the processing unit 61, the distance/direction identifier 62 identifies a distance between the vehicle C and an object (e.g., an object to be protected) in front of the vehicle C, and a direction of the object. The distance information and direction information provided from the radar device 36 may be directly used as the distance information and the direction information, for example. Alternatively, the direction information may be obtained based on image information captured by the camera 31.

The protected object identifier 63 identifies an object to be protected, if any, based on the image information provided from the camera 31. As described above, an object to be protected is a pedestrian or a cyclist, for example. The storage unit 60 stores the “pedestrian templates” and the “cyclist templates,” as described above. The protected object identifier 63 has a function of identifying a pedestrian or a cyclist from objects included in the image information.

The “object” here is a set of pixels included in the image information and having a contour. For example, the protected object identifier 63 recognizes an object having a contour shape similar to the pedestrian template, as a pedestrian, by referring to the pedestrian template. Likewise, the protected object identifier 63 recognizes an object having a contour shape similar to the cyclist template, as an aggregate, by referring to the cyclist template.

The protected object state detector 64 identifies states of an object to be protected, such as the moving direction and moving speed of the object. The protected object state detector 64 identifies the moving direction and moving speed of the object to be protected from a difference between the image data captured chronologically, for example. Additionally, the protected object state detector 64 also identifies a collision state predicted for the object. The determiner 65 determines whether or not to activate the airbag device 20 and the pop-up device 26, based on the processing results of the distance/direction identifier 62, the protected object identifier 63, the protected object state detector 64, and the like.

### <Collision State and Sensor Output>

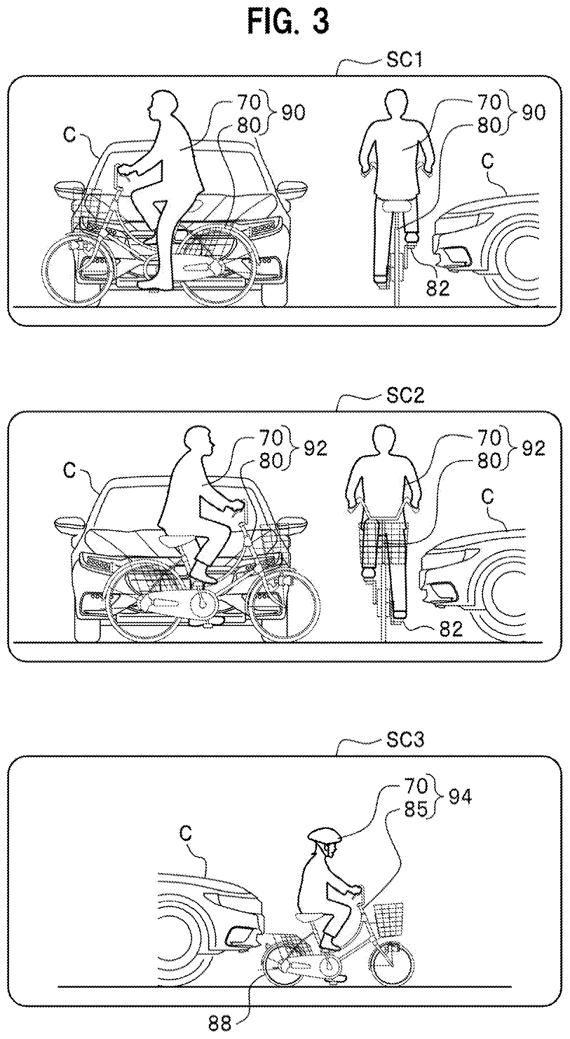

FIG. 3 illustrates examples of various collisions predicted by the protected object state detector 64. Hereinafter, a collision between an object to be protected and the vehicle C is referred to as a “scene.” A scene SC1 in FIG. 3 assumes a case where the vehicle C collides with a cyclist 90, crossing the road, from the side. Here, the cyclist 90 is an aggregate of a biker 70 and a bicycle 80 on which the biker rides. A pedal 82 of the bicycle 80 on a side to face the vehicle C is located near the top dead center. Note that “near the top dead center” refers to a rotation range of the pedal 82 within a predetermined range (e.g., plus or minus 45 degrees) around the top dead center.

In addition, a scene SC2 assumes a case where the vehicle C collides with a cyclist 92, crossing the road, from the side. Here, the cyclist 92 is also an aggregate of the biker 70 and the bicycle 80 on which the biker rides. However, in the scene SC2, the pedal 82 of the bicycle 80, on a side to face the vehicle C, is located near the bottom dead center. Note that “near the bottom dead center” refers to a rotation range of the pedal 82 within a predetermined range (e.g., plus or minus 45 degrees) around the bottom dead center.

In the scenes SC1 and SC2, wheels 84 of the bicycle 80 are assumed to have a rim diameter of 26 inches, for example. Further, a scene SC3 assumes a case where the vehicle C collides from behind with (rear-ends) a cyclist 94 (infant) traveling straight on the road. Here, the cyclist 94 is an aggregate of the biker 70 and a bicycle 85 on which the biker rides. However, it is assumed in the illustrated example that the bicycle 85 is for an infant and has wheels 88 having the rim diameter of 18 inches (i.e., type 18) or less. The biker 70, being an infant, and the bicycle 85 for an infant are both lightweight. Note that the sensor output is small in case of a rear-end collision, even if the cyclist is an adult.

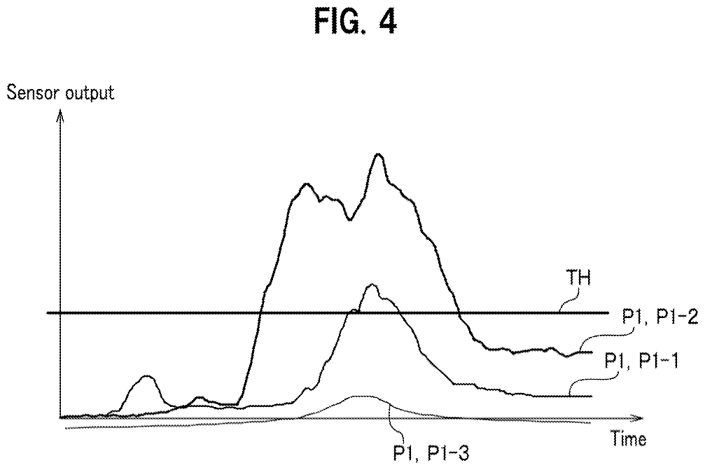

FIG. 4 is a chart showing an example of the output signal P1 of the pressure sensor 41 (see FIG. 2). In the scene SC2 shown in FIG. 3, the output signal P1 changes as an output signal P1-2 in FIG. 4, for example. The output signal P1-2 has exceeded a threshold TH, as indicated in the drawing, for a considerably long period. Accordingly, once the output signal P1 exceeds the threshold TH as indicated, it may be determined that “a collision has occurred.” In the scene SC2, this criterion almost certainly works to detect a collision. Activating the protection mechanism 2 (see FIG. 2), that is, the airbag device 20 and the pop-up device 26, after determining that “a collision has occurred,” allows for protecting the cyclist 92 as an object to be protected.

In addition, in the scene SC1 shown in FIG. 3, the output signal P1 changes as an output signal P1-1 shown in FIG. 4, for example. In the example as illustrated, the output signal P1-1 has a short period exceeding the threshold TH, but may not exceed the threshold TH, depending on a situation, to lead to a failure in detecting a collision between the vehicle C and the cyclist 90. This is because when the pedal 82 is near the top dead center to cause the foot of the biker 70 to be located high, as in the scene SC1 in FIG. 3, the cyclist 90 falls down with a relatively light force to cause a bumper face of the front bumper 18 (see FIG. 2) to be less deformed.

In order to reliably detect a collision in the scene SC1, the threshold TH may be further lowered from the level shown in FIG. 4. However, if the threshold TH is excessively lowered, the output signal P1 may rise to a level exceeding the threshold TH, when an event such as “a stone colliding with the vehicle C,” “a road cone colliding with the vehicle C,” or “the vehicle C running over a step” occurs, to unnecessarily activate the protection mechanism 2. Then, in the present embodiment, the threshold TH is normally set to the value shown in FIG. 4, for example, and the threshold TH is temporarily lowered when the scene SC1 is predicted to occur.

In the scene SC3 shown in FIG. 3, the output signal P1 changes as an output signal P1-3 shown in FIG. 4, for example. This is because the wheel 88 of the bicycle 85 goes under the pressure sensor 41 (see FIG. 1), when the vehicle C collides with (rear-ends) the bicycle 85 as in the scene SC3, to deform the front bumper 18, the chin spoiler 19, and the like so that the rising amount of the output signal P1 is extremely small. Additionally, as the cyclist 94 is of an infant, the weight of the biker 70 is light and the bicycle 85 is also light so that the output is also small. As described above, the bicycle 85 in the scene SC3 in FIG. 3 is a bicycle for a small rim diameter of 18 inches or less.

However, even if the bicycle is not for an infant but a normal bicycle having a rim diameter of about 26 inches, for example, the output signal P1 of the pressure sensor 41, when the vehicle C rear-ends the bicycle, has a waveform similar to the output signal P1-3. This is because the center of the wheel is about 13 inches (about 330 mm) high from the road surface even in a bicycle having a rim diameter of 26 inches, and this is lower than the mounting height h1 of the pressure sensor 41 (see FIG. 1). Therefore, in the present embodiment, the pressure sensor 42 is disposed under the pressure sensor 41 as shown in FIG. 1. In the scene SC3, even if the output signal P1 of the pressure sensor 41 does not rise significantly, the output signal P2 of the pressure sensor 42 rises significantly (not shown), to allow for detecting a collision as in the scene SC3.

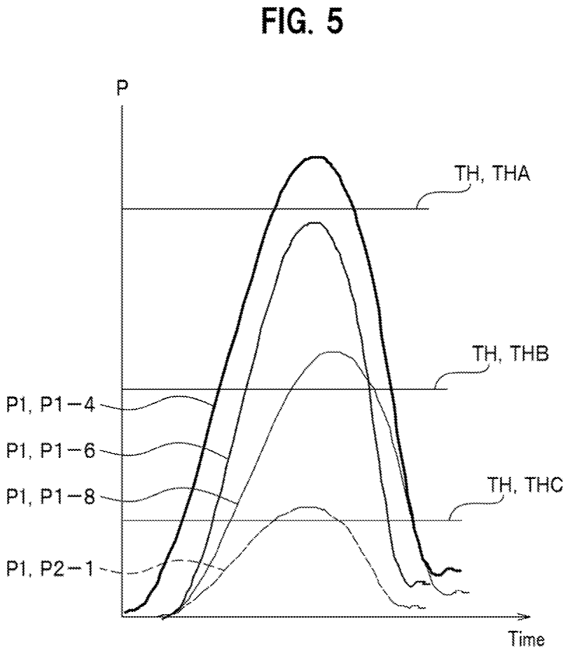

FIG. 5 is a chart illustrating various thresholds applied to the present embodiment. Output signals P1-4, P1-6, and P1-8 are the output signals P1 of the pressure sensor 41, schematically shown, and an output signal P2-1 is the output signal P2 of the pressure sensor 42, schematically shown. A threshold THA is a reference value of the threshold TH (see FIG. 4), and the threshold TH is set to the threshold THA, unless otherwise specified. That is, the threshold THA is applied such as when an object to be protected is a pedestrian, or when the object is a cyclist and predicted to collide with the vehicle C in a mode shown as the scene SC2 (see FIG. 3). In this case, the output signal P1 of the pressure sensor 41 changes as illustrated with the output signal P1-4, for example, and thus sufficiently exceeds the threshold THA.

In addition, the output signal P1-6 in FIG. 5 is an example of the output signal P1 when the vehicle C collides with a road cone (not shown). According to the illustrated example, the output signal P1-6 does not exceed the threshold THA, and thus unnecessary activation of the protection mechanism 2 (see FIG. 2) is avoided even if the vehicle C collides with the road cone. A threshold THB in FIG. 5 is a threshold TH temporarily applied when the scene SC1 (see FIG. 3) is predicted to occur. The output signal P1-8 is an example of the output signal P1 of the pressure sensor 41 in the scene SC1. As shown in the drawing, the output signal P1-8 sufficiently exceeds the threshold THB, so that occurrence of the scene SC1 can be detected with high accuracy.

Further, a threshold THC in FIG. 5 is a threshold TH temporarily applied when the scene SC3 (see FIG. 3) is predicted to occur. The output signal P2-1 is an example of the output signal P2 of the pressure sensor 42 in the scene SC3. The pressure sensor 42 is provided under the pressure sensor 41, as shown in FIG. 1, and thus the output signal P2-1 significantly increases even in the scene SC3 to exceed the threshold THC. This allows for detecting occurrence of the scene SC3 with high accuracy.

### Operation of Embodiment

### <Overview of Processing>

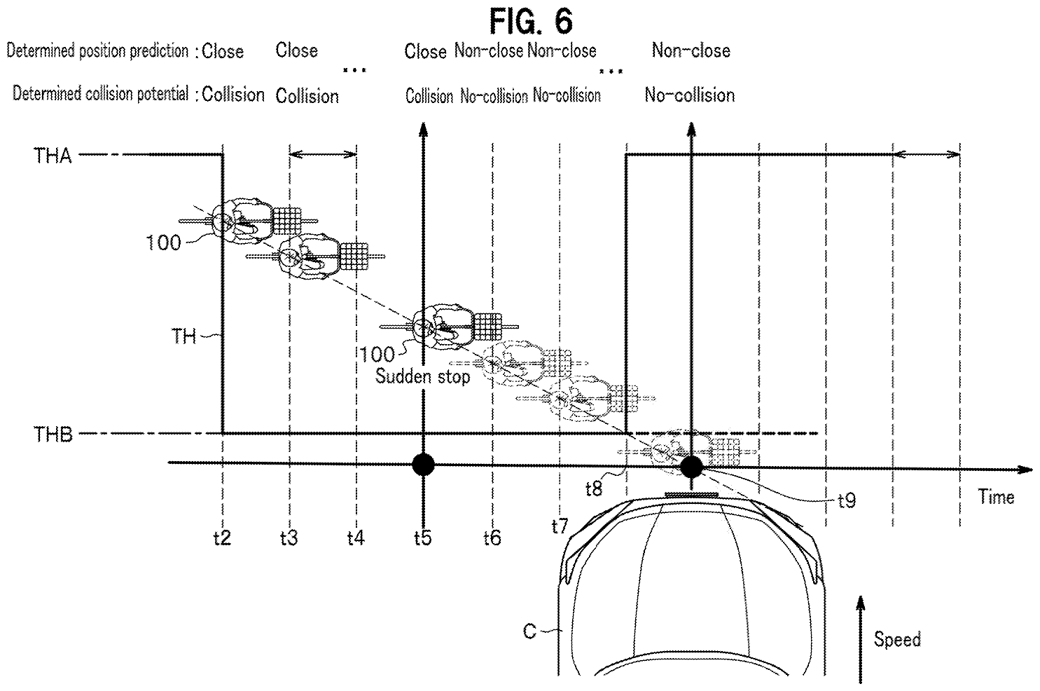

FIG. 6 is a schematic diagram to show general operation of the present embodiment. In FIG. 6, the horizontal axis represents time, and the vertical axis represents the distance between a protected object 100 and the vehicle C. The vertical axis also indicates the level of the threshold TH. The vehicle C travels straight at a speed v, and the protected object 100 is traveling in a direction orthogonal to the traveling direction of the vehicle C.

At time t2, the control device 6 (see FIG. 2) of the vehicle C is assumed to recognize the existence and state of the protected object 100 via the collision prediction/detection device 3. For example, it is assumed that the protected object 100 is a cyclist, the pedal 82 is positioned near the top dead center as shown in the scene SC1 in FIG. 3, and the control device 6 recognizes that the protected object 100 would collide with the vehicle C at time t9 (in the future).

The contents recognized by the control device 6 are updated at a predetermined control cycle (e.g., 100 milliseconds). Time t3 to time t9 in FIG. 6 represent times having one to seven control cycles lapsed, respectively, with reference to time t2. Additionally, at time t2, the control device 6 predicts positions of the protected object 100 at time t3 to time t9 to come. Hereinafter, a position predicted like this is referred to as a “predicted position.” The term “determined position prediction” in FIG. 6 indicates whether or not the predicted position is close to a result of measuring an actual position of the protected object 100.

Here, the term “close” indicates that the difference between the result of measuring an actual position of the protected object 100 and the predicted position of the same is within a predetermined allowable deviation. In contrast, the term “non-close” indicates otherwise. The term “determined collision potential” in FIG. 6 indicates whether or not a collision between the protected object 100 and the vehicle C is predicted. The term “collision” in the drawing indicates that a collision is predicted to be inevitable even by braking or steering operation of the vehicle C. In contrast, the term “no-collision” indicates that no collision is predicted, or that a collision is predicted to be avoidable by braking or steering operation of the vehicle C.

Assuming that the protected object 100 has been moving at a constant speed during the period of time t2 to time t5, the “determined position prediction” results in “close” and the “determined collision potential” results in “collision,” at time t3, time t4, and time t5. Here, it is assumed that the protected object 100 has noticed the presence of the vehicle C and suddenly stopped, at time t5. Then, the “determined position prediction” results in “non-close” and the “determined collision potential” is “no-collision,” at time t6 and beyond.

On the condition that a state of the “determined collision potential” being “no-collision” continues for a predetermined control time TA, the control device 6 sets the threshold TH back to the threshold THA as a reference value. In the illustrated example, the control time TA is 200 ms. That is, the threshold TH is set back to the threshold THA at time t8, because the “determined collision potential” has been “no-collision” during the control time TA of time t6 to time t8. Accordingly, even if the vehicle C collides with a road cone (not shown) or the like after time t8, unnecessary operation of the protection mechanism 2 (see FIG. 1) is avoided.

Note that the control time TA is 200 ms in the illustrated example, but the control time TA may be set to another value as long as it falls in a range of 100 ms to 10 seconds, inclusive, for example. The control device 6 may set the control time TA, based on a collision state (scenes SC1 to SC3), a moving speed of the protected object 100, a timing of collision prediction (time t9 in the illustrated example), a communication delay between the collision prediction/detection device 3 and the control device 6, a data calculation time in the collision prediction/detection device 3 or the control device 6, a degree of variation in data (position, moving speed) on the protected object 100, and the like.

### <Event Processing>

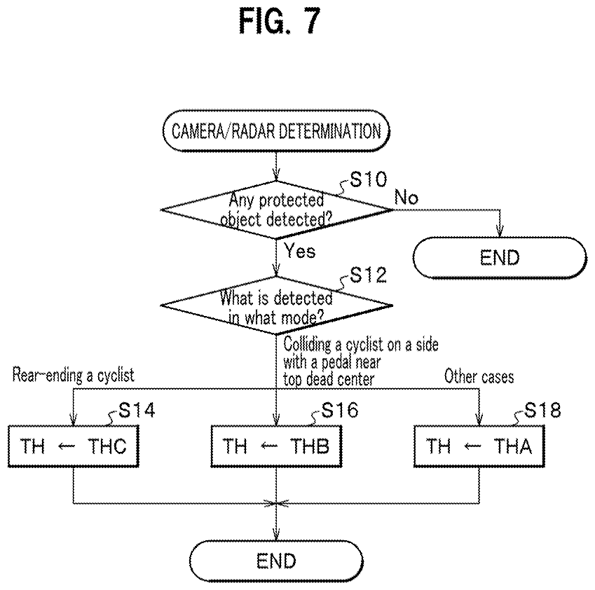

FIG. 7 is a flowchart of a camera/radar determination routine executed in the control device 6 (see FIG. 1). This routine is activated at every control cycle (e.g., 100 ms) as described above. In FIG. 7, when the processing proceeds to step S10, the determiner 65 determines whether or not the protected object identifier 63 has detected any protected object. Here, when the determination results in “No,” the routine ends. In contrast, when the determination results in “Yes” in step S10, the processing proceeds to step S12.

Here, the processing branches based on the “predicted collision state of the protected object” detected by the protected object state detector 64. First, in a case where a collision of the vehicle C rear-ending the cyclist (e.g., the scene SC3 in FIG. 3) is predicted, the processing proceeds to step S14 to set the threshold TH to the threshold THC, and then the processing of this routine ends. From this time onward, this causes the control device 6 to activate the protection mechanism 2 (see FIG. 2) when any of the output signals P1 and P2 (see FIG. 2) of the pressure sensors 41 and 42 exceeds the threshold THC.

Alternatively, in a case where the scene SC1 in FIG. 3 is predicted in step S12, the processing proceeds to step S16 to set the threshold TH to the threshold THB, and then the processing of this routine ends. From this time onward, this causes the control device 6 to activate the protection mechanism 2 when any of the output signals P1 and P2 of the pressure sensors 41 and 42 exceeds the threshold THB.

Still alternatively, in a case where a scene other than the scenes SC1 and SC3 is predicted in step S12, such as when the scene SC2 being predicted or when the protected object being a pedestrian, the processing proceeds to step S18. In step S18, the threshold TH is set to the threshold THA as a reference value, and then the processing of this routine ends. From this time onward, this causes the control device 6 to activate the protection mechanism 2 when any of the output signals P1 and P2 of the pressure sensors 41 and 42 exceeds the threshold THA.

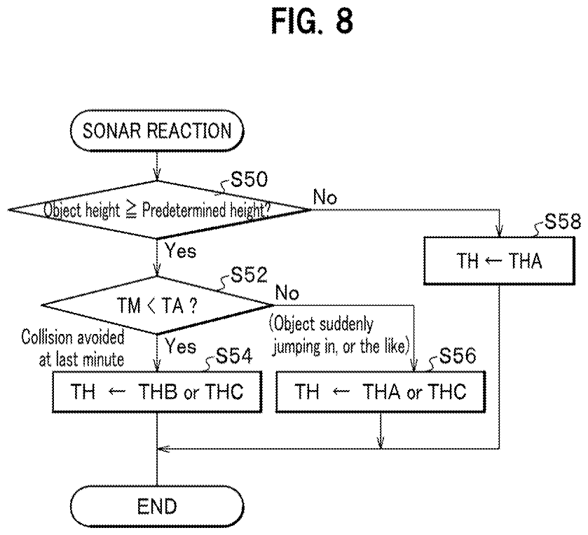

FIG. 8 is a flowchart of a sonar reaction routine executed in the control device 6 (see FIG. 1). This routine is activated when the “determined collision potential” in the control device 6 is “no-collision” and the sonar device 44 reacts. More specifically, the routine is activated in a case where, on the condition that the “determined collision potential” in the control device 6 is “no-collision,” an object is present in front of the vehicle C and the sonar device 44 detects the object.

In FIG. 8, the processing proceeds to step S50 to determine whether or not the height of the detected object is equal to or higher than a predetermined height. Here, the “predetermined height” is approximately the height of a dog or a cat, which is a height of about “30 cm” to “50 cm,” for example. When the determination results in “No” in step S50, the processing proceeds to step S58 to set the threshold TH to the threshold THA as a reference value, and then the processing of this routine ends. From this time onward, this causes the control device 6 to activate the protection mechanism 2 when any of the output signals P1 and P2 of the pressure sensors 41 and 42 exceeds the threshold THA.

In contrast, when the determination results in “Yes” in step S50, the processing proceeds to step S52 to determine whether or not a timer value TM is less than the control time TA. Here, the timer value TM is reset when the “determined collision potential” (see FIG. 6) has last been switched from “collision” to “no-collision,” and is counted up thereafter at every predetermined time (e.g., every one millisecond). That is, the timer value TM indicates an elapsed time since time t6, in the example in FIG. 6.

When the determination results in “Yes” in step S52, the processing proceeds to step S54. This case indicates that a collision has been avoided at the last minute. More specifically, the case represents a situation that the “determined collision potential” (see FIG. 6) by the control device 6 has been changed to “no-collision” after having been determined to be “collision” but before the control time TA elapsing, and corresponds to a situation from time t6 to time t8 in FIG. 6. Even in the situation from time t6 to time t8 in FIG. 6, the protected object 100 may jump in front of the vehicle C again. Then, if the sonar device 44 detects any object in such a case, the processing in step S54 is executed.

In step S54, the threshold THB or THC is set to the threshold TH. That is, if the threshold TH immediately before execution of step S54 is the threshold THB or THC, the threshold TH remains as it is. In contrast, if the threshold TH immediately before execution of step S54 is the threshold THA, the threshold TH is changed to the threshold THB in step S54, and then the processing of this routine ends. From this time onward, this causes the control device 6 to activate the protection mechanism 2 when any of the output signals P1 and P2 of the pressure sensors 41 and 42 exceeds the threshold THB or THC.

In contrast, when the determination results in “No” in step S52 in FIG. 8, the processing proceeds to step S56. This case indicates that the protected object has suddenly jumped in, or the like. The term “sudden jumping in” indicates a case where the protected object jumps in front of the vehicle C out of the shadow, for example. Additionally, when the protected object is a cyclist, the cyclist may travel in front of the vehicle C at the same speed as the vehicle C. In this case, if the cyclist suddenly applies a brake, the sonar device 44 may react before the “determined collision potential” by the control device 6 is changed to “collision.”

In step S56, the threshold TH is set to the threshold THA. However, if a “predetermined condition” is satisfied, the threshold TH is changed to the threshold THC. The “predetermined condition” is such a condition that “the output signal P1 of the pressure sensor 41 is equal to or less than the threshold THC and the output signal P2 of the pressure sensor 42 has exceeded the threshold THC.” After the processing in step S56 ends, the processing of this routine ends. Accordingly, from this time onward, when the above-described “predetermined condition” is satisfied, the control device 6 activates the protection mechanism 2 at that time. In contrast, in a case where the above-described “predetermined condition” is not satisfied, the control device 6 activates the protection mechanism 2 when any of the output signals P1 and P2 exceeds the threshold THA.

### Advantageous Effects of Embodiment

As described above, the vehicle-use object protection device (1) of the present embodiment includes: a sensor (41, 42) to output an output value (P1, P2) depending on an impact state when the vehicle (C) collides with the protected object (90 to 100); and a control device (6) to compare the output value (P1, P2) with a predetermined threshold (TH), and to activate the protection mechanism (2) when the output value (P1, P2) exceeds the threshold (TH) and then to lower the threshold (TH) when the collision prediction unit (3) determines that the vehicle collides with the cyclist. This allows for suitably protecting the protected object depending on the impact state, when the protected object collides with the vehicle (C).

In addition, the control device (6) has a function of predicting one of a plurality of collision states (SC1, SC3), and a function of setting a lowering amount (THA-THB, THA-THC) of the threshold (TH) depending on the predicted collision state (SC1, SC3). This allows for setting the threshold (TH) suitable for the collision state (SC1, SC3).

Further, the control device (6) further has: a function of setting the control time (TA) to maintain a lowered state of the threshold (TH), based on at least one of the collision state (SC1, SC3), a moving speed of the protected object (90 to 100), the timing of collision prediction (t9), the communication delay between the collision prediction unit (3) and the control device (6), the data calculation time in the collision prediction unit (3) or the control device (6), and the degree of variation in data for the protected object (90 to 100); and a function of maintaining the lowered state of the threshold (TH) since the timing at which the threshold (TH) has been lowered until the control time (TA) elapses. This allows for maintaining the lowered state of the threshold (TH) for the suitable control time (TA) depending on various factors.

Furthermore, the control device (6) further has a function of resetting the threshold (TH) back to the value before the lowering (THA) when the control time (TA) elapses since the timing of the threshold (TH) having been lowered. This allows for avoiding unnecessary activation of the protection mechanism (2) in such an event that the vehicle (C) collides with a road cone, a stone hits the vehicle (C), or the vehicle (C) runs over a step.

Moreover, the sensor (41, 42) includes a first sensor (41) provided at the front part of the vehicle (C), along the width direction of the vehicle (C), and a second sensor (42) provided under the first sensor (41), along the width direction of the vehicle (C). This allows the control device (6) to suitably detect various collision states.

### MODIFICATIONS

The present invention is not limited to the above-described embodiment, and various modifications are possible. The present invention has been described with the above-described embodiments for easy understanding thereof, but is not necessarily limited to those having all the configurations described above. Further, another configuration may be added to the configuration of the above-described embodiment, and/or a part of the configuration may be replaced with another configuration. Further, the control lines and information lines in the drawings indicate those considered necessary for the description, and do not necessarily indicate all the control lines and information lines required for the product. In fact, it can be considered that almost all components are connected to one another. The above-described embodiment may be modified as follows, for example.

(1) The vehicle C in the above-described embodiment is a passenger car having a motor room at the front of the vehicle body, as shown in FIG. 1, but the motor room may be provided at the center or rear of the vehicle body.

(2) As the hardware of the control device 6 in the above-described embodiment is implementable with a general computer, the programs indicated in FIGS. 7 and 8 may be stored in a storage medium for distribution, or distributed via a transmission path.

(3) The collision prediction/detection device 3 includes the single camera 31 and single radar device 36 in the above-described embodiment, but may include the two or more cameras 31. Additionally, the sonar device 44 may be included in the collision prediction/detection device 3.

(4) In the above-described embodiment, an example has been shown in which the threshold TH is lowered when the pedal position on the side facing the vehicle C is near the top dead center (see scene SC1 in FIG. 3) or when the vehicle C rear-ends a bicycle. However, the mode of lowering the threshold TH is not limited to that described in the above embodiment. For example, when the protected object is a bicycle, the collision energy is small regardless of the pedal position, because the bicycle has a high center of gravity, and thus the threshold TH may be lowered. When the protected object is a small person, the collision energy is also small. Therefore, the threshold TH may be lowered even when such a protected object is detected based on image information from the camera 31.

### LEGEND FOR REFERENCE NUMERALS

1: vehicle-use object protection device, 2: protection mechanism, 3: collision prediction/detection device (collision prediction unit), 6: control device, 20: airbag device, 26: pop-up device, 41: pressure sensor (sensor, first sensor), 42: pressure sensor (sensor, second sensor), 90 to 94: cyclist (protected object), 100: protected object, C: vehicle, P1; P2: output signal (output value), SC1 to SC3: scene (collision state), TA: control time, TH; THA; THB; THC: threshold, and t9: time (timing of collision prediction).

What is claimed is:

1. A vehicle-use object protection device comprising:
a protection mechanism to protect an object to be protected from a collision with a vehicle;
a collision prediction unit to predict a collision inclusive of a collision between the vehicle and at least a cyclist;
a sensor to output an output value depending on an impact state when the vehicle collides with the object; and
a control device to compare the output value with a predetermined threshold, and to activate the protection mechanism when the output value exceeds the threshold and then to lower the threshold when the collision prediction unit determines that the vehicle would collide with a cyclist.

2. The vehicle-use object protection device as claimed in claim 1, wherein
the control device has
a function of predicting one of a plurality of collision states, and
a function of setting a lowering amount of the threshold depending on the predicted collision state.

3. The vehicle-use object protection device as claimed in claim 2, wherein
the control device further has:
a function of setting a control time to maintain a lowered state of the threshold, based on at least one of the collision state, a moving speed of the object, a timing of collision prediction, a communication delay between the collision prediction unit and the control device, a data calculation time in the collision prediction unit or the control device, and the degree of variation in data for the object; and
a function of maintaining the lowered state of the threshold since the timing at which the threshold has been lowered until the control time elapses.

4. The vehicle-use object protection device as claimed in claim 3, wherein
the control device further has a function of resetting the threshold back to the value before the lowering when the control time elapses since the timing of the threshold having been lowered.

5. The vehicle-use object protection device as claimed in claim 1, wherein
the sensor includes:
a first sensor provided at a front part of the vehicle, along the width direction of the vehicle, and
a second sensor provided under the first sensor, along the width direction of the vehicle.
